(19) United States
(12) Patent Application Publication
(10) Pub. No.: US 2025/0054182 A1
(43) Pub. Date: Feb. 13, 2025

(54) ELECTRONIC DEVICE AND CONTROL METHOD APPLIED ON THE ELECTRONIC DEVICE

(71) Applicant: TRIPLE WIN TECHNOLOGY(SHENZHEN) CO.LTD., Shenzhen (CN)

(72) Inventors: CHING-HUANG LIN, Taoyuan (TW); Wei-Wei Qi, Shenzhen (CN); Chun-Ren Liu, Shenzhen (CN)

(21) Appl. No.: 18/543,573

(22) Filed: Dec. 18, 2023

(30) Foreign Application Priority Data
Aug. 9, 2023 (CN) 202311005318.4

(51) Int. Cl. G06T 7/73; G05B 15/02; G06F 3/16; G06T 7/55; G09G 3/20; H04N 23/66

(52) U.S. Cl. CPC G06T 7/73; G05B 15/02; G06F 3/165; G06T 7/55; G09G 3/20; H04N 23/66; G06T 2207/10028; G06T 2207/30196; G06T 2207/30244; G09G 2320/0626

(57) ABSTRACT

An electronic device includes a camera assembly, a function assembly, and a controller. The camera assembly is configured to capture a first depth image of a first user and a second depth image of the first user. The controller is configured to determine a first spatial position between the first user and the camera assembly according to the first depth image, and control the function assembly to execute a first action according to the first spatial position. The controller further configured to determine a relative displacement between the first user and the camera assembly according to the first depth image and the second depth image, and control the function assembly to execute a second action according to the relative displacement. The second action is an action to adjust a result of the function assembly based on the first action. A method and a non-transitory storage medium are also provided.

### FIELD

The subject matter herein generally relates to an electric technology, and particularly to an electronic device and a control method applied on the electronic device.

### BACKGROUND

Now, some control systems of some electronic devices cannot identify information of users, and thus, cannot control functions of the electronic devices according to results of identification. Thus, a barrier may be encountered by the user during using one electronic device. For example, a control system of a loudspeaker box cannot identify the information of the user, and cannot control the function of the loudspeaker box according to the result of identification. And, the user needs to operate a corresponding button on the loudspeaker box by hand, and the loudspeaker box can accordingly accomplish a corresponding function. However, the user cannot operate a volume adjustment button on the loudspeaker box manually anytime, so during a movement of the user away from the loudspeaker box, a volume heard by the user may be too small, and during a movement of the user toward the loudspeaker box, a volume heard by the user may be too large. Therefore, an experience of the user may be influenced.

### SUMMARY

An embodiment of the present application provides an electronic device, a control method applied on the electronic device, and a non-transitory storage medium capable of identifying information of users, controlling functions of the electronic devices according to results of identification, thus it is convenient for the use.

In a first aspect, an embodiment of the present application provides an electronic device. The electronic device includes a camera assembly, a function assembly, and a controller. The camera assembly is configured to capture a first depth image of a first user and a second depth image of the first user. The first depth image of the first user is a first frame of a depth image captured by the camera assembly in which the first user is present after the camera assembly is turned on. The second depth image of the first user and the first depth image of the first user are continuous depth images. The controller is configured to determine a first spatial position between the first user and the camera assembly according to the first depth image, and control the function assembly to execute a first action according to the first spatial position. The controller is further configured to determine a relative displacement between the first user and the camera assembly according to the first depth image and the second depth image, and control the function assembly to execute a second action according to the relative displacement, the second action is an action to adjust a result of the function assembly based on the first action.

According to some embodiments of the present application, the function assembly includes a playing assembly. The first spatial position includes a first distance. The controller is further configured to determine a first volume according to the first distance, and control the playing assembly to play sound at the first volume.

According to some embodiments of the present application, the relative displacement includes a distance of the relative displacement. The controller is further configured to determine a size of change in a volume according to the distance of the relative displacement, and adjust a size of the volume of the sound played by the playing assembly on the first volume according to the size of change in the volume.

According to some embodiments of the present application, the function assembly includes a display assembly, the first spatial position includes a first distance. The controller is further configured to determine a first brightness according to the first distance, and control the display assembly to display information at a first brightness.

According to some embodiments of the present application, the relative displacement includes a distance of the relative displacement. The controller is further configured to determine a size of change in a brightness according to the distance of the relative displacement, and adjust a size of the brightness of the information displayed by the display assembly on the first brightness according to the size of change in the brightness.

According to some embodiments of the present application, the function assembly includes a driving assembly, the first spatial position includes a first relative direction. The controller is further configured to determine a first angle according to the first relative direction, and control the driving assembly to drive a display assembly and/or a playing assembly to rotate the first angle, causing the display assembly and/or the playing assembly to face the first user.

According to some embodiments of the present application, the relative displacement includes a direction of the relative displacement. The controller is further configured to determine a size of change in an angle according to the direction of the relative displacement, and control the driving assembly to drive the display assembly and/or the playing assembly to rotate the size of change in the angle on the first angle, causing the display assembly and/or the playing assembly to face the first user.

According to some embodiments of the present application, the camera assembly is further configured to capture a third depth image of a second user. The controller is further configured to determine a third spatial position between the second user and the camera assembly according to the third depth image, and control the function assembly to execute a third action according to the third spatial position if a third distance of the third spatial position is less than a first distance of the first spatial position or if the third distance of the third spatial position is less than a second distance of a second spatial position determined from the second depth image.

According to some embodiments of the present application, the electronic device further includes a sound reception assembly, the sound reception assembly is configured to receive voice information of the first user. The controller is further configured to control the camera assembly to turn on according to the voice information of the first user.

In a second aspect, an embodiment of the present application provides a control method. The method controls a camera assembly to capture a first depth image of a first user. The first depth image of the first user is a first frame of a depth image captured by the camera assembly in which the first user is present after the camera assembly is turned on. The method determines a first spatial position between the first user and the camera assembly according to the first depth image. The method controls a function assembly to execute a first action according to the first spatial position. The method controls the camera assembly to capture a second depth image of the first user. The second depth image of the first user and the first depth image of the first user are continuous depth images. The method determines a relative displacement between the first user and the camera assembly according to the first depth image and the second depth image. The method further controls the function assembly to execute a second action according to the relative displacement, the second action is an action to adjust a result of the function assembly based on the first action.

According to some embodiments of the present application, the first spatial position includes a first distance. The control method further determines a first volume according to the first distance, and controls a playing assembly of the function assembly to play sound at the first volume.

According to some embodiments of the present application, the relative displacement includes a distance of the relative displacement. The control method further determines a size of change in a volume according to the distance of the relative displacement, and adjusts a size of the volume of the sound played by the playing assembly on the first volume according to the size of change in the volume.

According to some embodiments of the present application, the first spatial position includes a first distance. The control method determines a first brightness according to the first distance, and controls a display assembly of the function assembly to display information at a first brightness.

According to some embodiments of the present application, the relative displacement includes a distance of the relative displacement. The control method further determines a size of change in a brightness according to the distance of the relative displacement, and adjusts a size of the brightness of the information displayed by the display assembly on the first brightness according to the size of change in the brightness.

According to some embodiments of the present application, the first spatial position includes a first relative direction. The control method further determines a first angle according to the first relative direction, and controls a driving assembly of the function assembly to drive a display assembly and/or a playing assembly to rotate the first angle, causing the display assembly and/or the playing assembly to face the first user.

According to some embodiments of the present application, the relative displacement includes a direction of the relative displacement. The control method further determines a size of change in an angle according to the direction of the relative displacement, and controls the driving assembly to drive the display assembly and/or the playing assembly to rotate the size of change in the angle on the first angle, causing the display assembly and/or the playing assembly to face the first user.

According to some embodiments of the present application, the control method further controls the camera assembly to capture a third depth image of a second user, and determines a third spatial position between the second user and the camera assembly according to the third depth image. The control method further controls the function assembly to execute a third action according to the third spatial position if a third distance of the third spatial position is less than a first distance of the first spatial position or if the third distance of the third spatial position is less than a second distance of a second spatial position determined from the second depth image.

According to some embodiments of the present application, the control method further controls the camera assembly to turn on according to voice information of the first user.

In a third aspect, an embodiment of the present application provides a non-transitory storage medium storing a set of commands, when the set of commands being executed by at least one processor of an electronic device, causing the at least one processor to control a camera assembly to capture a first depth image of a first user. The first depth image of the first user being a first frame of a depth image captured by the camera assembly in which the first user is present after the camera assembly is turned on. The non-transitory storage medium further causes the at least one processor to determine a first spatial position between the first user and the camera assembly according to the first depth image, and control a function assembly to execute a first action according to the first spatial position. The non-transitory storage medium further causes the at least one processor to control the camera assembly to capture a second depth image of the first user; the second depth image of the first user and the first depth image of the first user being continuous depth images. The non-transitory storage medium further causes the at least one processor to determine a relative displacement between the first user and the camera assembly according to the first depth image and the second depth image, and control the function assembly to execute a second action according to the relative displacement, the second action is an action to adjust a result of the function assembly based on the first action.

According to some embodiments of the present application, the non-transitory storage medium further causes the at least one processor to determine a size of change in a volume according to a distance of the relative displacement, and adjust a size of the volume of the sound played by a playing assembly of the function assembly on a first volume formed by the first action according to the size of change in the volume. The non-transitory storage medium further causes the at least one processor to determine a size of change in a brightness according to the distance of the relative displacement, and adjust a size of the brightness of the information displayed by a display assembly of the function assembly on a first brightness formed by the first action according to the size of change in the brightness.

In the disclosure, after the camera assembly captures the first depth image of the first user, the controller determines the first spatial position between the first user and the camera assembly according to the first depth image, and controls the function assembly to execute the first action according to the first spatial position, thus the electronic device can identify the first user on a position, and provide the corresponding service for the first user according to a first result of the identification. And after the camera assembly captures the second depth image of the first user, the controller determines the relative displacement between the first user and the camera assembly according to the first depth image and the second depth image, and controls the function assembly to execute the second action according to the relative displacement, thus the electronic device can identify the first user who is moving, and provide the corresponding service for the first user according to a second result of the identification.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram illustrating an electronic device according to an embodiment of the present disclosure.

FIG. 2 is a block diagram illustrating a detail of the electronic device shown in FIG. 1.

FIG. 3 is a schematic view illustrating the electronic device shown in FIG. 2 according to an embodiment of the present disclosure.

FIG. 4A is an application scenario view illustrating the electronic device shown in FIG. 1 according to an embodiment of the present disclosure.

FIG. 4B is an application scenario view illustrating the electronic device shown in FIG. 1 according to another embodiment of the present disclosure.

FIG. 5 is an application scenario view illustrating the electronic device shown in FIG. 3 according to an embodiment of the present disclosure.

FIG. 6 is an application scenario view illustrating the electronic device shown in FIG. 3 according to another embodiment of the present disclosure.

FIG. 7 is an application scenario view illustrating the electronic device shown in FIG. 3 according to another embodiment of the present disclosure.

FIG. 8 is a flowchart illustrating a control method according to an embodiment of the present disclosure.

FIG. 9 is a block diagram illustrating an electronic device according to another embodiment of the present disclosure.

### DETAILED DESCRIPTION

“A plurality of” in this application means two or more. In the descriptions of this application, terms such as “first” and “second” are merely used for distinction and description, and should not be understood as an indication or implication of relative importance or an indication or implication of an order.

In addition, the term “for example” in the embodiments of this application is used to represent giving an example, an illustration, or a description. Any embodiment or implementation solution described as an “example” in this application should not be explained as being more preferred or having more advantages than another embodiment or implementation solution. Exactly, the term “example” is used to present a concept in a specific manner.

A brief description of related technologies is as follows.

Now, a control system of an electronic device cannot identify information of a user, and accordingly cannot automatically control a function of the electronic device according to a result of identification. Or, an identification manner of the control system of the electronic device is single and an identification capability of the control system of the electronic device is weak. For example, the control system of the electronic device can turn on the electronic device according to a voice command of the user. Thus, an experience of the user may be influenced. For example, a control system of a loudspeaker box cannot identify the information of the user, and accordingly cannot control the function of the loudspeaker box according to the result of identification. And, the user needs to operate a corresponding button on the loudspeaker box by hand, and the loudspeaker box can accordingly achieve a corresponding function. In an application scenario, the user cannot operate a volume adjustment button on the loudspeaker box by hand anytime, thus the volume of a sound played by the loudspeaker box cannot be adjusted anytime, and the loudspeaker box is held constant volume.

For avoiding operating the volume adjustment button on the loudspeaker box manually, another loudspeaker box can automatically adjust the played volume of the sound. However, during a movement of the user away from the loudspeaker box, a volume of the sound played by the another loudspeaker box may be held constant, thus a volume heard by the user may be too small. And during a movement of the user toward the loudspeaker box, the volume of the sound played by the another loudspeaker box is held constant, thus a volume heard by the user may be too large. For example, in a short time, the user may move from a position A to another position B, and then return back to the position A. The position A relative to the position B is away from the loudspeaker box. However, during the movement of the user from the position A to the position B, and from the position B to the position A, the volume of the sound played by the loudspeaker box is held constant. Thus, during the movement of the user, the volume heard by the user may be too large. Thus, an experience of the user may be influenced.

The disclosure provides an electronic device and a control method capable of identifying the information of the user and controlling the electronic device in real time according to the result of the identification, thus it is convenient for the user to use the electronic device.

The electronic device of the present embodiment can be a household appliance, for example, a loudspeaker box, a television, a dehumidifier, an air cleaner, or the like.

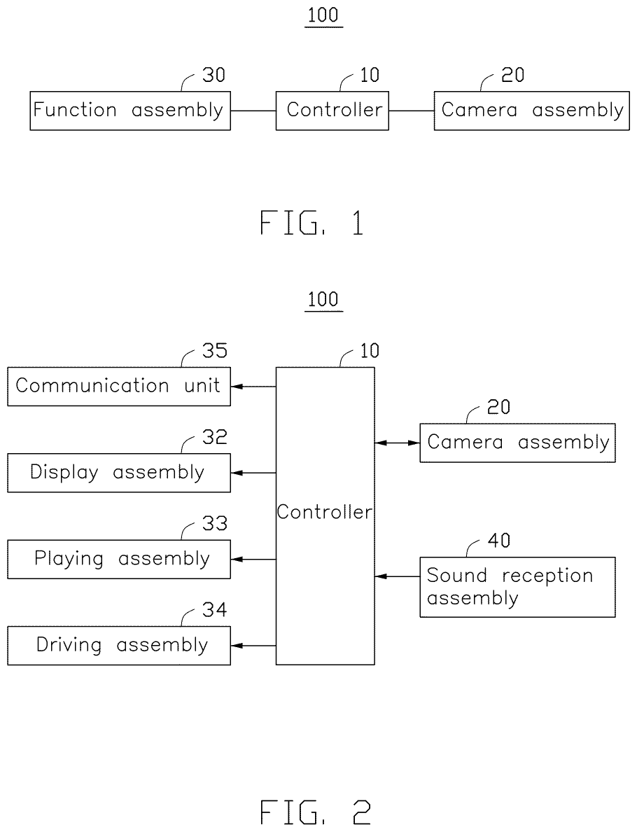

Referring to FIG. 1, FIG. 1 is a block diagram illustrating an electronic device according to an embodiment of the present disclosure. The electronic device 100 includes a controller 10, a camera assembly 20, and a function assembly 30. The controller 10 is coupled to the camera assembly 20 and the function assembly 30. The camera assembly 20 can be a depth camera assembly 20. The camera assembly 20 can be configured to capture a depth image of the user. The depth image of the user can include position information of the user in real space. In detail, a pixel gradation value of the depth image represents a distance in real space between the user and the camera assembly 20, and a pixel position of the depth image represents an orientation of the user in real space. Thus, the controller 10 can determine a spatial position between the user and the camera assembly 20 according to the depth image, and determine a relative displacement between the user and the camera assembly 20 according to different depth images. The controller 10 can further generate a first control command according to the spatial position, and generate a second control command according to the relative displacement. The controller 10 can further control the function assembly 30 to execute a first action according to the first control command, and control the function assembly 30 to execute a second action according to the second control command, thus the function assembly 30 can achieve a corresponding function.

In detail, the controller 10 can compare each depth image and a number of pre-stored image models of the user to determine whether a user is present in a corresponding depth image. When the user is present in the depth image, the controller 10 can determine the spatial position between the user and the camera assembly 20, and control the function assembly 30 to execute the first action according to the first control command.

The controller 10 can further determine the relative displacement between the user and the camera assembly 20, and control the function assembly 30 to execute the second action according to the second control command. It can be understood that the controller 10 can omit to generate the control command, and directly control the function assembly 30 to execute the first action according to the spatial position, and directly control the function assembly 30 to execute the second action according to the relative displacement, the disclosure is not limited herein.

It can be understood that the controller 10 can be omitted.

Referring to FIG. 2, the electronic device 100 is shown in detail. The electronic device 100 of FIG. 2 is similar to the electronic device 100 of FIG. 1, except that:

In FIG. 2, in the embodiment, the electronic device 100 further includes a sound reception assembly 40. The sound reception assembly 40 is coupled to the controller 10. The sound reception assembly 40 is configured to receive voice information of the user, and transmit the received voice information to the controller 10. The controller 10 can generate a third control command according to the voice information. The controller 10 can further control the camera assembly 20 and/or the function assembly 30 to execute an action according to the third control command, thus the function module can achieve a corresponding function.

It can be understood that, the electronic device 100 can include both the sound reception assembly 40 and the camera assembly 20, thus the electronic device 100 can achieve a voice recognition function and a spatial position recognition function, the electronic device 100 can accordingly have a number of identification capabilities, and an identification capability for the information of the user can be accordingly improved.

In some embodiments, the function assembly 30 includes a display assembly 32, a playing assembly 33, and a driving assembly 34.

The display assembly 32 is configured to display information, for example display real-time information. The display assembly 32 can include a display screen. The display assembly 32 can be a LCD (liquid crystal display), a OLED (organic light-emitting diode), an AMOLED (active-matrix organic light emitting diode), a FLED (flex light-emitting diode), a MiniLED, a MicroLED, a Micro-OLED, a QLED (quantum dot light emitting diodes), or the like. The playing assembly 33 is configured to play the sound. The sound can be music, a broadcast, or the like. The playing assembly 33 can include a loudspeaker unit, a crossover, and so on. The crossover is configured to optimize the sound. For example, the crossover can perform an amplitude-frequency characteristic correction and a phase-frequency characteristic correction on an electric signal. The loudspeaker unit is configured to convert the corrected electric signal to the sound, and play the sound. The driving assembly 34 is configured to drive the display assembly 32 and the playing assembly 33 to rotate. The driving assembly 34 can include a motor, and so on.

In some embodiments, the electronic device 100 can further include a communication unit 35. The communication unit 35 can be a Wi-Fi unit, a Bluetooth unit, or the like. The communication unit 35 is configured to enable the electronic device 100 to establish a connection with an internet, to achieve an information obtained from the internet. For example, the communication unit 35 can enable the electronic device 100 to obtain the real-time information from the internet. The real-time information can be time, date, news, and so on. The communication unit 35 can further enable the electronic device 100 to transmit the real-time information to the controller 10. The controller 10 can process the real-time information and transmit the processed real-time information to the display assembly 32 to display. In some embodiments, a priority of the third control command is higher than a priority of the first control command, and a priority of the third control command is higher than a priority of the second control command. Namely, a priority of the sound reception assembly 40 is higher than a priority of the camera assembly 20. Thus, when the function assembly 30 receives the first control command and the third control command, the function assembly 30 preferentially executes the third control command. And when the function assembly 30 receives the second control command and the third control command, the function assembly 30 preferentially executes the third control command.

For example, when the user enters into a position identification range of the camera assembly 20, the camera assembly 20 captures the depth image of the user and transmits the depth image of the user to the controller 10. The controller 10 generates the first control command according to the depth image of the user. The first control command is configured to indicate to start the driving assembly 34 and indicate the driving assembly 34 to drive the display assembly 32 and the playing assembly 33 to rotate. At the moment, the sound reception assembly 40 receives the voice information of the user, and the controller 10 generates the third control command according to the voice information of the user. The third control command is configured to indicate the driving assembly 34 to stop driving the display assembly 32 and the playing assembly 33. According to the first control command and the third control command, the controller 10 performs the third control command, namely the controller 10 can control the driving assembly 34 to stop driving the display assembly 32 and the playing assembly 33.

The position identification range of the camera assembly 20 can be a preset range, for example a field of view of 5 meters from the camera assembly 20, the disclosure is not limited herein.

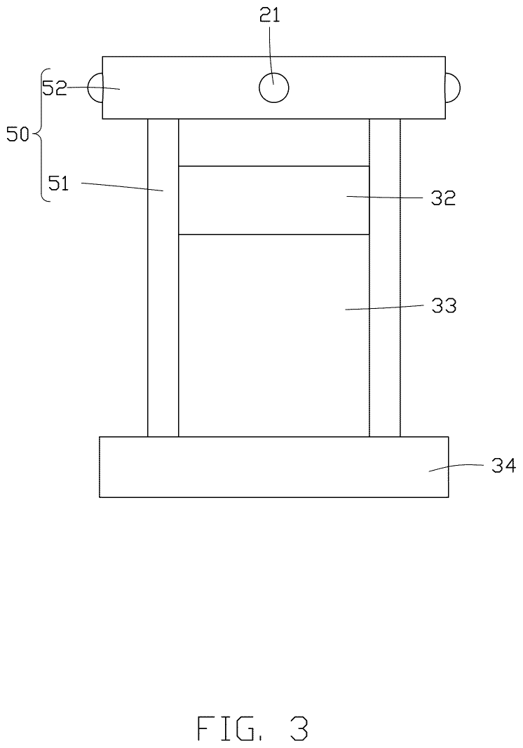

Referring also to FIG. 3, FIG. 3 is a schematic view illustrating the electronic device 100 shown in FIG. 2 according to another embodiment of the present disclosure. The electronic device 100 further includes a cabinet 50. The cabinet 50 includes a cabinet main body 51 and a top cover 52. The cabinet main body 51 is movably coupled to the top cover 52. In some embodiments, the cabinet main body 51 and the top cover 52 each can be a cylinder, a central axis of the cabinet main body 51 and a central axis of the top cover 52 are coincided, and a cross-sectional area of the cabinet main body 51 is greater than a cross-sectional area of the top cover 52. It can be understood that, a shape of the cabinet main body 51 and a shape of the top cover 52 can be others, for example each can be a cuboid, the disclosure is not limited herein.

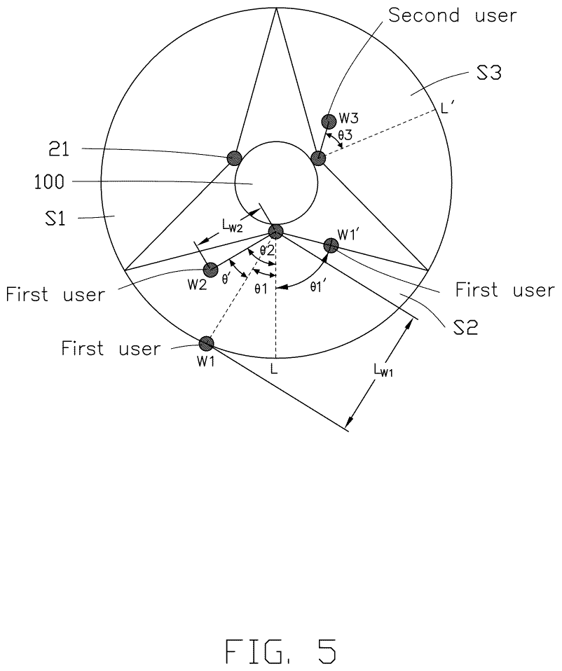

The camera assembly 20 includes one or more cameras 21. Each camera 21 is configured to capture a depth image. In some embodiments, the one or more cameras 21 are arranged on a sidewall of the top cover 52 and are spaced from each other, thus it is convenient for the one or more cameras 21 to capture the depth image of the user. As shown in FIG. 5, FIG. 5 shows a top view of the electronic device 100, three cameras 21 are arranged equidistantly on the sidewall of the top cover 52, the horizontal position identification ranges of the three cameras 21 are respectively S1, S2, and S3. The horizontal position identification ranges of the camera assembly 20 is a total of the horizontal position identification ranges of the three cameras 21. It can be understood that, the position identification range of the camera assembly 20 can be adjusted via adjusting a number of the cameras 21 and adjusting the position where the cameras 21 are arranged on the top cover 52, for example, when the number of the cameras 21 is four, the position identification range of the camera assembly 20 is a range which is 360 degrees around the electronic device 100 and 5 meters from the camera assembly 20, the disclosure is not limited herein.

The cabinet main body 51 defines a receiving space. The receiving space is internal to the cabinet main body 51. The receiving space is configured to receive some component of the electronic device 100. For example, the receiving space can receive the controller 10, the communication unit 35, and the sound reception assembly 40. In the embodiment, the controller 10, the communication unit 35, and the sound reception assembly 40 are fixed in the receiving space. The display assembly 32 and the playing assembly 33 each is arranged on the cabinet main body 51. The display assembly 32 and the playing assembly 33 are arranged in transverse rows or in longitudinal rows on the cabinet main body 51, or a number of playing assemblies are arranged around the display assembly 32. It can be understood that, the position of the playing assembly 33 and the position of the display assembly 32 can be others, the disclosure is not limited herein.

The driving assembly 34 is arranged at a bottom of the cabinet main body 51. The driving assembly 34 is configured to drive the cabinet main body 51 to rotate, the cabinet main body 51 is configured to bring the display assembly 32 and the playing assembly 33 to rotate. It can be understood that, the cabinet main body 51 is rotatably coupled to the top cover 52. When the driving assembly 34 drives the cabinet main body 51 to rotate, the top cover 52 can keep still, thus the cameras 21 arranged on the sidewall of the top cover 52 can capture the depth image steadily.

In some embodiments, a speed for capturing the depth image by the camera assembly 20 is quicker, the cameras 21 can capture any quick movement of the user. The capturing assembly is configured to capture a first depth image of the first user and a second depth image of the first user. In some embodiments, the second depth image of the first user is different from the first depth image of the first user. Once the camera assembly 20 captures one depth image, the controller 10 immediately obtains the one depth image from the camera assembly 20. For example, once the camera assembly 20 captures the first depth image, the controller 10 immediately obtains the first depth image from the camera assembly 20, and once the camera assembly 20 captures the second depth image, the controller 10 immediately obtains the second depth image from the camera assembly 20.

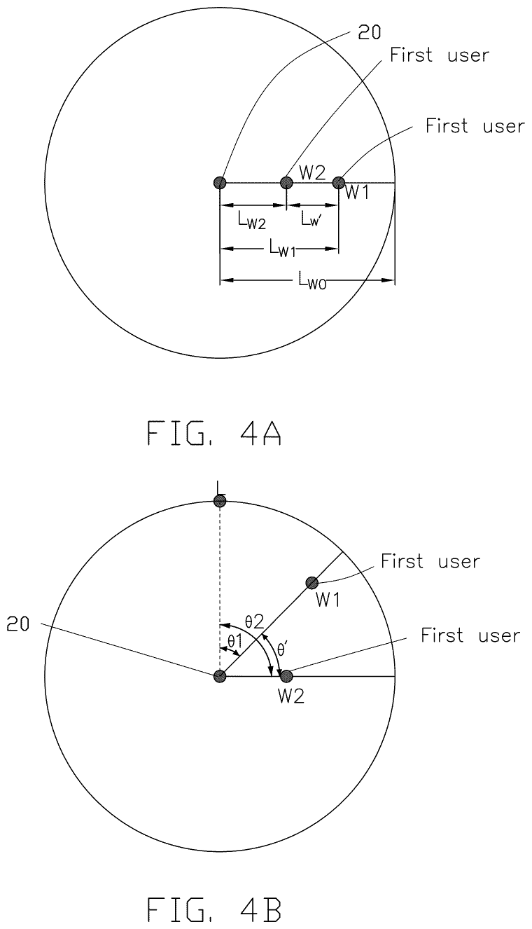

The first depth image can represent a first spatial position between the first user and the camera assembly 20 within the position identification range of the camera assembly 20. The second depth image can represent a second spatial position between the first user and the camera assembly 20 within the position identification range of the camera assembly 20. The position identification range of the camera assembly 20 can include an identification distance and an identification angle. The identification distance of the capturing assembly is L_{W0}, as shown in FIG. 4A. The identification angle of the capturing assembly is an angle range which is rotated by 0 degrees to 360 degrees on a distance between the camera assembly 20 and a point L, as shown in FIG. 4B. It can be understood that, the identification distance of the capturing assembly and the identification range of the capturing assembly can be set according to practical situations, for example, the identification angle can be from 0 degrees to 120 degrees, the disclosure is not limited herein.

The first spatial position includes a first distance and a first relative direction. For example, as shown in FIG. 4A, the first distance L_{W1} can be a distance between the first user and the camera assembly 20 when the first user is at a first position W1. And for example, as shown in FIG. 4B, the first relative direction θ1 can be an angle formed by a first line segment connecting the first position W1 and the camera assembly 20 and a second line segment connecting the camera assembly 20 and the point L. The second spatial position includes a second distance and a second relative direction. For example, as shown in FIG. 4A, the second distance L_{W2} can be a distance between the first user and the camera assembly 20 when the first user is at the second position W2. And for example, as shown in FIG. 4B, the second relative direction θ2 can be an angle formed by a third line segment connecting the second position W2 and the camera assembly 20 and a fourth line segment connecting the camera assembly 20 and the point L.

The controller 10 is configured to determine the first spatial position between the first user and the camera assembly 20 according to the first depth image, and control the function assembly 30 to execute the first action according to the first spatial position. In some embodiments, the first depth image can be a first frame of the depth image captured by the camera assembly 20 in which at least one user is present after the camera assembly 20 is turned on, and the second depth image can be a second frame of the depth image captured by the camera assembly 20 after the camera assembly 20 captures the first frame of the depth image. It can be understood that, if there is no first user in the depth image obtained continuous after the first depth image, the procedure ends.

The controller 10 can take the first distance and/or the first relative direction as one or more control parameters, to control the display assembly 32, the playing assembly 33, and/or the driving assembly 34 to execute the first action. In some embodiments, the controller 10 controls the playing assembly 33 to play sound at a first volume and the display assembly 32 to display information at a first brightness according to the first distance. Namely, the first volume and the first brightness is formed by the first action.

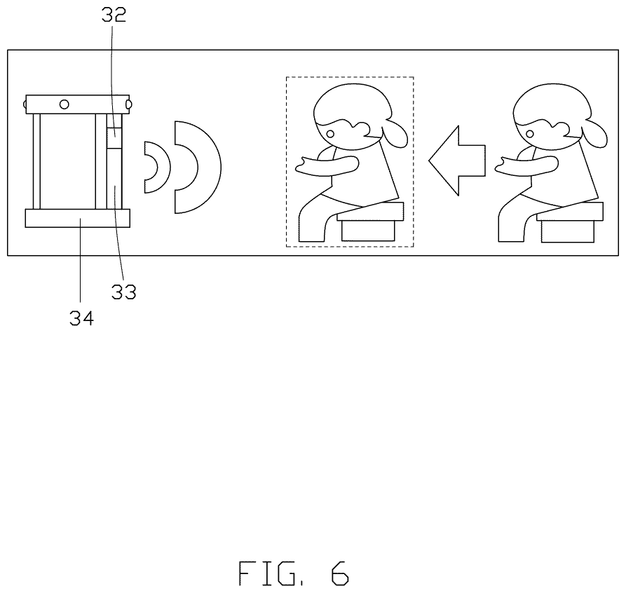

For example, as shown in FIG. 5 and FIG. 6, in the first depth image, the first user is at the first position, when the first position is the position W1, the controller 10 controls the playing assembly 33 to play at a first level volume and the display assembly 32 to display at a first level brightness. When the first position is the position W1′, the controller 10 controls the playing assembly 33 to play at a second level volume and the display assembly 32 to display at a second level brightness. Where the position W1 is away from the electronic device 100 relative to the position W1′, the first level volume is greater than the second level volume, and the first level brightness is greater than the second level brightness.

In some embodiment, the electronic device 100 further stores a first relationship among a distance range, a volume, and a brightness. For example, when the distance range is 0˜3 meters, a corresponding volume is one level, and a corresponding brightness is one level, and when the distance range is 3˜6 meters, a corresponding volume is two levels, and a corresponding brightness is two levels. When the distance between the first position and the electronic device 100 is within the distance range 0˜3 meters, the controller 10 can control the playing assembly 33 to play at the one level volume and the display assembly 32 to display at the one level brightness. In some embodiments, the first relationship can be stored in the controller 10. It can be understood that, the first relationship can be stored in a storage unit of the electronic device 100, the disclosure is not limited herein. In some embodiments, the first distance can be directly proportional to the size of the volume and the size of the brightness, the disclosure is not limited herein.

It can be understood that, the controller 10 can control the playing assembly 33 to play sound at the first volume according to the first distance, thus the first user can always hear an appropriate size of the volume while the first user is at any first position. The controller 10 can control the displaying assembly 33 to display information at the first brightness according to the first distance, the first user can feel an appropriate size of the brightness while the first user is at any first position, thus the first user can see the displayed information clearly.

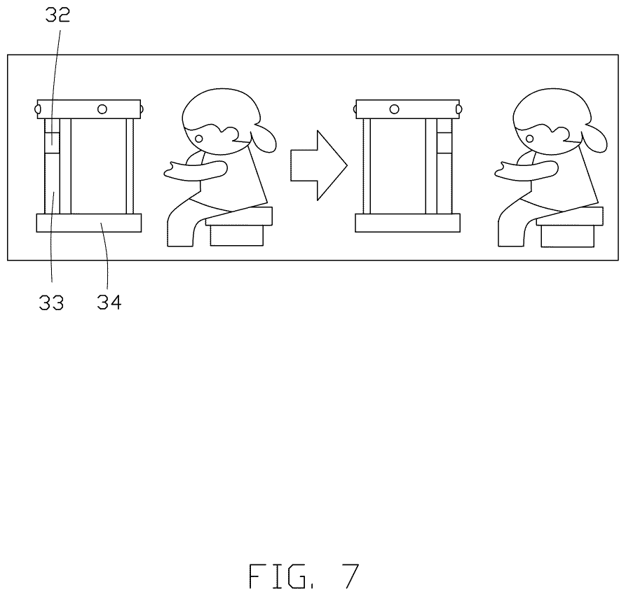

In some embodiments, the controller 10 can control the driving assembly 34 to drive the displaying assembly 33 and/or the playing assembly 33 to rotate a first angle according to the first relative direction, causing the display assembly 32 and/or the playing assembly 33 to face the first user. For example, as shown in FIG. 5, in an initial state, the display assembly 32 and/or the playing assembly 33 on the cabinet main body 51 face the point L. In the first depth image, the first user is at the first position. In FIG. 5, when the first position is the position W1, the controller 10 controls the driving assembly 34 to drive the cabinet main body 51 to rotate an angle θ1. At the moment, as shown in FIG. 7, the cabinet main body 51 brings the display assembly 32 and the playing assembly 33 to rotate the angle θ1, causing the display assembly 32 and the playing assembly 33 to face the first user. When the display assembly 32 faces the first user, the first user can see the information displayed by the display assembly 32 timely. When the playing assembly 33 faces the first user, there is no obstacle between the first user and the loudspeaker of the playing assembly 33, thus the first user can hear the sound clearly.

It can be understood that, the display assembly 32 facing the first user can be a display screen of the display assembly 32 facing the first user, and the playing assembly 33 facing the first user can be a loudspeaker of the playing assembly 33 facing the first user, the disclosure is not limited herein.

In some embodiments, the electronic device 100 further stores a second relationship between a direction range and the angle. For example, when the direction range is 0 degrees˜10 degrees, a corresponding angle is 5 degrees. When the angle formed by the first line segment connecting the first position W1 and the camera assembly 20 and the second line segment connecting the camera assembly 20 and the point L is within the direction range 0 degrees˜10 degrees, the controller 10 can determine that the first angle is 5 degrees according to the second relationship, and control the driving assembly 34 to drive the display assembly 32 and/or the playing assembly 33 to rotate an angle 5 degrees, causing the display assembly 32 and/or the playing assembly 33 to face the first user. In some embodiments, the second relationship can be stored in the controller 10. It can be understood that, the second relationship can be stored in the storage unit of the electronic device 100, the disclosure is not limited herein. In some embodiments, the first angle is equal to the first relative direction, the disclosure is not limited herein.

It can be understood that, the number of the cameras 21 of the camera assembly 20 and the position of the cameras 21 arranged on the top cover 52 can influence the position identification range of the camera assembly 20 and a shape of a boundary of the position identification range of the camera assembly 20, thus when the first user is at different positions of the boundary of the position identification range of the camera assembly 20, the first spatial position between the first user and the camera assembly 20 can be different. The controller 10 can determine the first spatial position between the first user and the camera assembly 20 according to the first depth image, and control the function assembly 30 to execute the first action according to the first spatial position between the first user and the camera assembly 20. Thus, the electronic device 100 can also provide a facilitated service for the first user at any position of the boundary of the position identification range of the camera assembly 20.

The controller 10 is further configured to determine a relative displacement between the first user and the camera assembly 20 according to the first depth image and the second depth image, and control the function assembly 30 to execute the second action according to the relative displacement. The second action is an action to adjust a result of the function assembly based on the first action. The result of the function assembly can include the size of the volume of the sound played by the playing assembly, the size of the brightness of the information displayed by the display assembly, and the angle of the display assembly and/or the playing assembly.

The relative displacement includes a distance of the relative displacement and a direction of the relative displacement. Namely, the controller 10 can further take the distance of the relative displacement and/or the direction of the relative displacement as one or more control parameters, to control the display assembly 32, the playing assembly 33, and/or the driving assembly 34 to execute the second action.

In detail, the controller 10 is further configured to determine the second spatial position between the first user and the camera assembly 20 according to the second depth image, and determine the relative displacement between the first user and the camera assembly 20 according to the first spatial position and the second spatial position.

As shown in FIG. 5, the first user moves from the first position W1 to the second position W2, the distance of the relative displacement between the first user and the camera assembly 20 is a difference value obtained by the second distance L_{w1} subtracting the first distance L_{w2}, namely L_{W}. And the direction of the relative displacement between the first user and the camera assembly 20 is a difference value obtained by the second relative direction θ2 subtracting the first relative direction θ1, namely θ′. Where when the distance of the relative displacement between the first user and the camera assembly 20 is a positive value, it represents that the first user moves away from the camera assembly 20. When the distance of the relative displacement between the first user and the camera assembly 20 is a negative value, it represents that the first user moves toward the camera assembly 20. When the direction of the relative displacement between the first user and the camera assembly 20 is a positive value, it represents that the first user moves clockwise about the camera assembly 20. When the direction of the relative displacement between the first user and the camera assembly 20 is a negative value, it represents that the first user moves anticlockwise about the camera assembly 20.

In some embodiments, the controller 10 can determine a size of change in the volume and a size of change in the brightness according to the distance of the relative displacement. The controller 10 can further adjust the size of the volume of the sound played by the playing assembly 33 on the first volume according to the size of the change in the volume, and adjust the size of the brightness of the information displayed by the display assembly 32 on the first brightness according to the size of the change in the brightness. The distance of the relative displacement is directly proportional to the size of the change in the volume, and the distance of the relative displacement is directly proportional to the size of the change in the brightness. For example, as shown in FIG. 5, in the first depth image, the first user is at the first position W1, and in the second depth image, the first user is at the second position W2. When the first user moves from the first position W1 to the second position W2, the controller 10 determines that the size of the change in the volume is minus one level and the size of the change in the brightness is minus one level according to the distance of the relative displacement, and controls the size of the volume played by the playing assembly 33 to reduce one level from the first level volume to a third level volume, and the size of the brightness displayed by the display assembly 32 to reduce one level from the first level brightness to a third level brightness.

In some embodiments, the electronic device 100 can further store a third relationship among the distance of the relative displacement, the size of the change in the volume, and the size of the change in the brightness. The controller 10 can further determine the size of the change in the volume and the size of the change in the brightness according to the third relationship and the distance of the relative displacement. In some embodiments, the third relationship can be stored in the controller 10. It can be understood that, the third relationship can be stored in the storage unit of the electronic device 100, the disclosure is not limited herein.

It can be understood that, the disclosure determines a distance of the relative displacement according to two continuous depth images of the first user, thus the disclosure can accurately detect any quicker movement of the first user. The disclosure determines a size of the change in the volume according to the distance of the relative displacement, and controls the size of the volume played by the playing assembly 33, the disclosure can adjust the volume in real time during any indefinitely small quick movement of the first user, thus the first user can always hear an appropriate size of the volume. The disclosure determines a size of the change in the brightness according to the distance of the relative displacement, and controls the size of the brightness displayed by the display assembly 32, the disclosure can adjust the brightness in real time during any indefinitely small quick movement of the first user, thus the first user can always feel an appropriate size of the brightness and can see the displayed information clearly.

In some embodiments, the controller 10 determines a size of change in the angle according to the direction of the relative displacement, and controls the driving assembly 34 to drive the display assembly 32 and/or the playing assembly 33 to rotate the size of the change in the angle on the first angle, causing the display assembly 32 and/or the playing assembly 33 to face the first user. For example, as shown in FIG. 5, in the first depth image, the first user is at the first position W1, and in the second depth image, the first user is at the second position W2. When the first user moves from the first position W1 to the second position W2, the controller 10 determines that the size of the change in the angle is plus θ′ according to the direction of the relative displacement, and controls the driving assembly 34 to drive the cabinet main body 51 to rotate the angle θ′ clockwise. The cabinet main body 51 brings the display assembly 32 and the playing assembly 33 to rotate the angle θ′ clockwise, causing the display assembly 32 and the playing assembly 33 to face the first user. When the display assembly 32 faces the first user, the first user can see the information displayed by the display assembly 32 timely during any indefinitely small quick movement of the first user. When the playing assembly 33 faces the first user, there is no obstacle between the first user and the loudspeaker of the playing assembly 33 thus the first user can hear the sound clearly during any indefinitely small quick movement of the first user.

It can be understood that, the disclosure controls the function assembly 30 to execute the second action according to the relative displacement, thus the electronic device 100 can provide a facilitated service for the first user during any indefinitely small and quick movement of the first user.

Thus, after the camera assembly 20 captures the first depth image, the controller 10 determines the first spatial position between the first user and the camera assembly 20 according to the first depth image, and controls the function assembly 30 to execute the first action according to the first spatial position. Thus, the electronic device 100 can identify the spatial position of the user in the depth image, and provide a corresponding function service for the user according to an identification result of the spatial position of the user. After the camera assembly 20 captures the second depth image, the controller 10 determines the relative displacement between the first user and the camera assembly 20 according to the first depth image and the second depth image, and controls the function assembly 30 to execute the second action according to the relative displacement. The second action is an action to adjust based on the first action. Thus, the electronic device 100 can identify any indefinitely small quick movement of the user, and provide a corresponding function service for the user according to an identification result of the any indefinitely small quick movement of the user.

In some embodiments, the size of the change of the angle is equal to the direction of the relative displacement, the disclosure is not limited herein.

In some embodiments, the controller 10 can further obtain a third depth image of a second user, and determine a third spatial position between the second user and the camera assembly 20 according to the third depth image of the second user.

The third depth image can represent a third spatial position between the second user and the camera assembly 20 within the position identification range of the camera assembly 20. It can be understood that, the user in the position identification range may be not only one, for example, as shown in FIG. 5, in the position identification range, the first user is at the first position W1, and the second user is at a third position W3. The controller 10 can determine the third spatial position between the second user and the camera assembly 20 according to the third depth image. The third spatial position includes a third distance and a third relative direction, for example, as shown in FIG. 5, the third distance is L_{w3}, and the third relative direction is θ3.

If the third distance of the third spatial position is less than the first distance or the second distance, the controller 10 can further control the function assembly 30 to execute a third action according to the third spatial position.

It can be understood that, the third distance of the third spatial position being less than the first distance or the second distance, represents that the second user is closer to the camera assembly 20 than the first user. The camera assembly 20 can preferentially control the function assembly 30 to execute the third action according to the third spatial position, thus the electronic device 100 can preferentially provide the facilitated service for the second user who is closer to the camera assembly 20 than the first user.

It can be understood that, the second user can be in the first depth image or the second depth image; if the third distance of the third spatial position is greater than the first distance and the second distance, the electronic device 100 can preferentially provide the facilitated service to the first user, the disclosure is not limited herein.

In some embodiments, as shown in FIG. 5, the first user is at the first position W1, the display assembly 32 and the playing assembly 33 each faces the first user, the playing assembly 33 plays the sound at the first level volume and the display assembly 32 displays the content at the first level brightness. At the moment, the second user enters into the position identification range of the camera assembly 20, and is at the third position W3. The camera assembly 20 captures the third depth image of the second user who is at the third position W3, the controller 10 determines the third distance L_{w3} and the third relative direction θ3 according to the third depth image. The controller 10 compares the first distance L_{w1} and the third distance L_{w3}, and determines that the third distance L_{w3} is less than the first distance L_{w1}. The controller 10 further controls the display assembly 32 and the playing assembly 33 to rotate from facing the first user to facing the second user according to the third relative direction θ3, and controls the playing assembly 33 to play the sound at the third volume and the displaying assembly 33 to display the content at the third brightness.

In some embodiments, the controller 10 is further configured to control the function assembly 30 to execute a fourth action according to a voice command, for example, the controller 10 is further configured to control the camera assembly 20 to be at a turned on state according to the voice command. It can be understood that, the camera assembly 20 is at a turned off state at the initial state.

In detail, the camera assembly 20 at the turned on state represents that, the camera assembly 20 can capture a fourth depth image of the object in the position identification range. For example, when the cameras 21 of the camera assembly 20 is turned on, there is some objects (for example a desk and a wall) in the position identification range, the camera assembly 20 can capture the fourth depth image including the desk and the wall.

In some embodiments, the sound reception assembly 40 receives the voice of the first user for turning on the camera assembly 20, and transmits the voice to the controller 10. The controller 10 can generate a corresponding third control command according to the voice, and turn on the camera assembly 20 according to the corresponding third control command. Thus, the camera assembly 20 can capture the fourth depth image of the object in the position identification range. The voice for turning on the camera assembly 20 can be defined in advance, the voice can be, for example “turn on” or “play the sound”. It can be understood that, the manner to turn on the camera assembly 20 can be other, for example turn on the camera assembly 20 by hand, the disclosure is not limited herein.

It can be understood that, after the camera assembly 20 captures the second depth image, the camera assembly 20 further captures the fifth depth image. The fifth depth image and the second depth image are continuous depth images. The controller 10 can determine continuously a new relative displacement between the first user and the camera assembly 20 according to the second depth image and the fifth depth image, and control continuously the function assembly 30 to execute a fifth action according to the new relative displacement. The fifth action is an action to adjust based on the second action.

It can be understood that, the electronic device 100 can perform continuously the aforementioned procedure until an end condition is met, for example the camera assembly 20 is turned off, the electronic device 100 is turned off, or the first user moves out from the position identification range of the camera assembly 20, the disclosure is not limited herein.

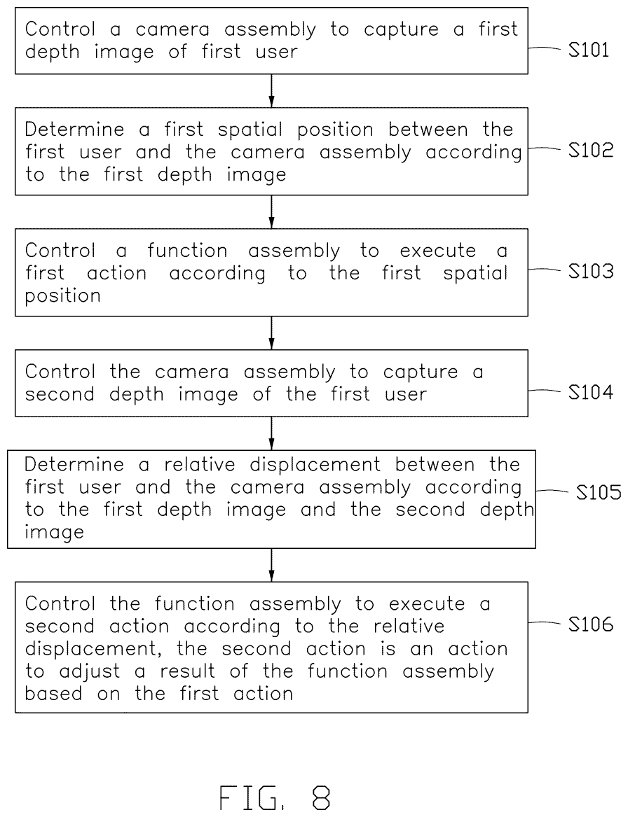

Referring to FIG. 8, a control method is provided. The control method is applied on the electronic device. In detail, the control method is applied on the controller of the electronic device. The control method includes:
S101, controlling the camera assembly to capture the first depth image of the first user; the first depth image of the first user is the first frame of depth image captured by the camera assembly in which the first user is present after the camera assembly is turned on.
S102, determining the first spatial position between the first user and the camera assembly according to the first depth image.
S103, controlling the function assembly to execute the first action according to the first spatial position.
S104, controlling the camera assembly to capture the second depth image of the first user, the second depth image of the first user and the first depth image of the first user are continuous depth images.
S105, determining the relative displacement between the first user and the camera assembly according to the first depth image and the second depth image.
S106, controlling the function assembly to execute the second action according to the relative displacement, the second action is an action to adjust a result of the function assembly based on the first action.

In some embodiments, the first spatial position includes the first distance and the first relative direction, the S106 further includes:
S201, determining the first volume and the first brightness according to the first distance.
S202, controlling the playing assembly to play sound at the first volume and the display assembly to display information at the first brightness.
S203, determining the first angle according to the first relative direction.
S204, controlling the driving assembly to drive the display assembly and/or the playing assembly to rotate the first angle, causing the display assembly and/or the playing assembly to face the first user.

It can be understood that, the S203˜S204 can be executed before the S201˜S202, or the S203˜S204 can be executed at the same time with the S201˜S202.

In some embodiments, the relative displacement includes the distance of the relative displacement and the direction of the relative displacement, the S106 includes:
S301, determining the size of the change in the volume and the size of the change in the brightness according to the distance of the relative displacement.
S302, adjusting the size of the volume of the sound played by the playing assembly on the first volume according to the size of the change in the volume, and adjusting the size of the brightness of the information displayed by the display assembly on the first brightness according to the size of the change in the brightness.
S303, determining the size of the change in the angle according to the direction of the relative displacement.
S304, controlling the driving assembly to drive the display assembly and/or the playing assembly to rotate the size of the change in the angle on the first angle, causing the display assembly and/or the playing assembly to face the first user.

It can be understood that, the S303˜S304 can be executed before the S301˜S302, or the S303˜S304 can be executed at the same time with the S301˜S302.

In some embodiments, the control method further includes:
S401, controlling the camera assembly to capture the third depth image of the second user.
S402, determining the third spatial position between the second user and the camera assembly according to the third depth image.
S403, controlling the function assembly to execute the third action according to the third spatial position if the third distance of the third spatial position is less than the first distance or if the third distance of the third spatial position is less than the second distance.

It can be understood that, the S401˜S403 can be executed after any of the S102˜S105.

In some embodiments, before S101, the control method further includes:
S501, controlling the camera assembly to turn on according to the voice command.

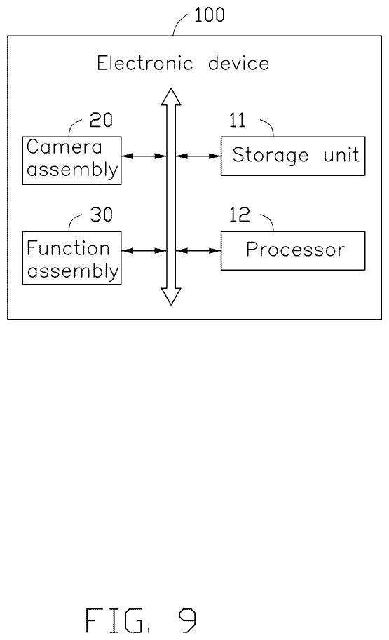

In some embodiments, the controller can include a storage unit 11 and a processor 12, as shown in FIG. 9. In FIG. 9, the electronic device 100 further includes the camera assembly 20 and the function assembly 30. The storage unit 11 may be configured to store a software program and module/unit. The processor 12 runs the software program and module/unit stored in the storage unit 11, and invokes the data stored in the storage unit 11, to implement various functions of the electronic device. The storage unit 11 may include a program storage area and a data storage area. The program storage area may store an operating system, an application program required by at least one function (such as an image display function), and the like. The data storage area may store data (such as the second vehicle and so on) created according to use of the electronic device, and the like. In addition, the storage unit 11 may include a non-transitory storage medium, such as a hard disk, a memory, or the like. It can be understood that, the storage unit 11 may further include a non-transitory storage medium, such as a pluggable hard disk, a smart media card (SMC), a secure digital (SD) card, a flash card, at least one magnetic disk storage device, a flash storage unit, or another volatile solid-state storage device.

The processor 12 can include one or more central processing units (CPUs), and further include one or more general-purpose processors, one or more digital signal processors (DSPs), one or more application specific integrated circuits (ASICs), one or more field-programmable gate arrays (FPGAs), or other one or more programmable logic devices, one or more discrete gates or transistor logics, one or more discrete hardware components, and so on. The processor 12 can be a microprocessor or the processor can be any conventional processor. The processor 12 is the control center of the electronic device, and is connected to various parts of the electronic device by using various interfaces and lines.

A person skilled in the art may understand that, the structure shown in FIG. 9 imposes no limitation on the electronic device, and the electronic device may include more or fewer components than those shown in the figure, or combine some components, or divide some components, or have different component arrangements.

It can be understood that, the controller can be omitted from the electronic device, and the electronic device can include the storage unit 11 and the processor 12 as shown in FIG. 9, the disclosure is not limited herein.

The disclosure further provides a storage medium configured to store one or more programs. A processor of the electronic device can execute the one or more programs to accomplish the steps of the exemplary method.

In the several embodiments provided in the present application, it should be understood that the disclosed device and method may be implemented in other manners. For example, the described device embodiment is merely exemplary. For example, the module division or the unit division is merely a logical function division and there may be other bases of division in actual implementation. For example, multiple units or components may be combined or integrated into another device, or some features may be ignored or not performed.

In addition, functional units in the embodiments of the present invention may be integrated into one processing unit, or each of the units may exist alone physically, or two or more units are integrated into one unit.

Based on the description of the foregoing implementation manners, a person skilled in the art may clearly understand that the present disclosure may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented using corresponding hardware. Moreover, a specific hardware structure used to achieve a same function may be of various forms, for example, in a form of an analog circuit, a digital circuit, a dedicated circuit, or the like. However, as for the present disclosure, software program implementation is a better implementation manner in most cases. Based on such an understanding, the technical solutions of the present disclosure essentially or the part contributing to the prior art may be implemented in a form of a software product. The software product is stored in a readable storage medium, such as a floppy disk, a universal serial bus (USB) flash drive, a removable hard disk, a read-only memory (ROM), a random access memory (RAM), a magnetic disk, or an optical disc of a computer, and includes several instructions for instructing a computer device (which may be a personal computer, a server, a network device, and the like) to perform the methods described in the embodiments of the present disclosure.

All or some of the foregoing embodiments may be implemented by means of software, hardware, firmware, or any combination thereof. When software is used to implement the embodiments, the embodiments may be implemented completely or partially in a form of a computer program product.

The computer program product includes one or more computer instructions. When the computer program instructions are loaded and executed on the computer, the procedure or functions according to the embodiments of the present disclosure are all or partially generated. The computer may be a general-purpose computer, a special-purpose computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive Solid State Disk (SSD)), or the like.

Those skilled in the art should understand that, the present disclosure is not limited to the specific embodiments described herein, and various obvious changes, readjustments and substitutions that are made by those skilled in the art will not depart from the scope of the present disclosure. Therefore, although the present disclosure has been described in detail by the above embodiments, the present disclosure is not limited to the above embodiments, and more other equivalent embodiments may be included without departing from the concept of the present disclosure, and the scope of the present disclosure is determined by the scope of the appended claims.

What is claimed is:

1. An electronic device comprising:
a camera assembly configured to capture a first depth image of a first user and a second depth image of the first user, the first depth image of the first user being a first frame of a depth image captured by the camera assembly in which the first user is present after the camera assembly is turned on, the second depth image of the first user and the first depth image of the first user being continuous depth images;
a function assembly; and
a controller configured to determine a first spatial position between the first user and the camera assembly according to the first depth image, and control the function assembly to execute a first action according to the first spatial position, wherein
the controller further configured to determine a relative displacement between the first user and the camera assembly according to the first depth image and the second depth image, and control the function assembly to execute a second action according to the relative displacement, the second action is an action to adjust a result of the function assembly based on the first action.

2. The electronic device according to claim 1, wherein:
the function assembly comprises a playing assembly, the first spatial position comprises a first distance, and
the controller is further configured to determine a first volume according to the first distance, and control the playing assembly to play sound at the first volume.

3. The electronic device according to claim 2, wherein:
the relative displacement comprises a distance of the relative displacement, and
the controller is further configured to determine a size of change in a volume according to the distance of the relative displacement, and adjust a size of the volume of the sound played by the playing assembly on the first volume according to the size of change in the volume.

4. The electronic device according to claim 1, wherein:
the function assembly comprises a display assembly, the first spatial position comprises a first distance, and
the controller is further configured to determine a first brightness according to the first distance, and control the display assembly to display information at a first brightness.

5. The electronic device according to claim 4, wherein:
the relative displacement comprises a distance of the relative displacement, and
the controller is further configured to determine a size of change in a brightness according to the distance of the relative displacement, and adjust a size of the brightness of the information displayed by the display assembly on the first brightness according to the size of change in the brightness.

6. The electronic device according to claim 1, wherein:
the function assembly comprises a driving assembly, the first spatial position comprises a first relative direction, and
the controller is further configured to determine a first angle according to the first relative direction, and control the driving assembly to drive a display assembly and/or a playing assembly to rotate the first angle, causing the display assembly and/or the playing assembly to face the first user.

7. The electronic device according to claim 6, wherein:
the relative displacement comprises a direction of the relative displacement, and
the controller is further configured to determine a size of change in an angle according to the direction of the relative displacement, and control the driving assembly to drive the display assembly and/or the playing assembly to rotate the size of change in the angle on the first angle, causing the display assembly and/or the playing assembly to face the first user.

8. The electronic device according to claim 1, wherein:
the camera assembly is further configured to capture a third depth image of a second user, and
the controller is further configured to determine a third spatial position between the second user and the camera assembly according to the third depth image, and control the function assembly to execute a third action according to the third spatial position if a third distance of the third spatial position is less than a first distance of the first spatial position or if the third distance of the third spatial position is less than a second distance of a second spatial position determined from the second depth image.

9. The electronic device according to claim 1, further comprising:
a sound reception assembly, wherein the sound reception assembly is configured to receive voice information of the first user, and
the controller is further configured to control the camera assembly to turn on according to the voice information of the first user.

10. A control method comprising:
controlling a camera assembly to capture a first depth image of a first user, the first depth image of the first user being a first frame of a depth image captured by the camera assembly in which the first user is present after the camera assembly is turned on;
determining a first spatial position between the first user and the camera assembly according to the first depth image;
controlling a function assembly to execute a first action according to the first spatial position;
controlling the camera assembly to capture a second depth image of the first user, the second depth image of the first user and the first depth image of the first user being continuous depth images;
determining a relative displacement between the first user and the camera assembly according to the first depth image and the second depth image; and
controlling the function assembly to execute a second action according to the relative displacement, wherein the second action is an action to adjust a result of the function assembly based on the first action.

11. The control method according to claim 10, wherein the first spatial position comprises a first distance, the control method further comprises:
determining a first volume according to the first distance; and
controlling a playing assembly of the function assembly to play sound at the first volume.

12. The control method according to claim 11, wherein the relative displacement comprises a distance of the relative displacement, the control method further comprises:
determining a size of change in a volume according to the distance of the relative displacement; and
adjusting a size of the volume of the sound played by the playing assembly on the first volume according to the size of change in the volume.

13. The control method according to claim 10, wherein the first spatial position comprises a first distance, the control method further comprises:
determining a first brightness according to the first distance; and
controlling a display assembly of the function assembly to display information at a first brightness.

14. The control method according to claim 13, wherein the relative displacement comprises a distance of the relative displacement, the control method further comprises:
determining a size of change in a brightness according to the distance of the relative displacement; and
adjusting a size of the brightness of the information displayed by the display assembly on the first brightness according to the size of change in the brightness.

15. The control method according to claim 10, wherein the first spatial position comprises a first relative direction, the control method further comprises:
determining a first angle according to the first relative direction; and
controlling a driving assembly of the function assembly to drive a display assembly and/or a playing assembly to rotate the first angle, causing the display assembly and/or the playing assembly to face the first user.

16. The control method according to claim 15, wherein the relative displacement comprises a direction of the relative displacement, the control method further comprises:
determining a size of change in an angle according to the direction of the relative displacement; and
controlling the driving assembly to drive the display assembly and/or the playing assembly to rotate the size of change in the angle on the first angle, causing the display assembly and/or the playing assembly to face the first user.

17. The control method according to claim 10, wherein the control method further comprises:
controlling the camera assembly to capture a third depth image of a second user;
determining a third spatial position between the second user and the camera assembly according to the third depth image; and
controlling the function assembly to execute a third action according to the third spatial position if a third distance of the third spatial position is less than a first distance of the first spatial position or if the third distance of the third spatial position is less than a second distance of a second spatial position determined from the second depth image.

18. The control method according to claim 10, further comprising:
controlling the camera assembly to turn on according to voice information of the first user.

19. A non-transitory storage medium storing a set of commands, when the set of commands being executed by at least one processor of an electronic device, causing the at least one processor to:
control a camera assembly to capture a first depth image of a first user, the first depth image of the first user being a first frame of a depth image captured by the camera assembly in which the first user is present after the camera assembly is turned on,
determine a first spatial position between the first user and the camera assembly according to the first depth image,
control a function assembly to execute a first action according to the first spatial position;
control the camera assembly to capture a second depth image of the first user, the second depth image of the first user and the first depth image of the first user being continuous depth images,
determine a relative displacement between the first user and the camera assembly according to the first depth image and the second depth image, and
control the function assembly to execute a second action according to the relative displacement, wherein the second action is an action to adjust a result of the function assembly based on the first action.

20. The non-transitory storage medium according to claim 19, further causing the at least one processor to:
determine a size of change in a volume according to a distance of the relative displacement, and adjusting a size of the volume of the sound played by a playing assembly of the function assembly on a first volume formed by the first action according to the size of change in the volume;
determine a size of change in a brightness according to the distance of the relative displacement, and adjusting a size of the brightness of the information displayed by a display assembly of the function assembly on a first brightness formed by the first action according to the size of change in the brightness.
